(19) United States
(12) Patent Application Publication
(10) Pub. No.: US 2013/0191414 A1
(43) Pub. Date: Jul. 25, 2013

(54) METHOD AND APPARATUS FOR PERFORMING A DATA SEARCH ON MULTIPLE USER DEVICES

(71) Applicant: Samsung Electronics Co., Ltd., Gyeonggi-do (KR)

(72) Inventors: Alok SRIVASTAVA, Bangalore (IN); Anubhav DIKSHIT, Bangalore (IN); Malur Nagendra Srivatsa BHARADWAJ, Bangalore (IN); Shatrughan SINGH, Bangalore (IN)

(73) Assignee: Samsung Electronics Co., Ltd., Gyeonggi-do (KR)

(21) Appl. No.: 13/747,049

(22) Filed: Jan. 22, 2013

(30) Foreign Application Priority Data
Jan. 20, 2012 (IN) 256/CHE/2012

(51) Int. Cl. G06F 17/30

(52) U.S. Cl. CPC G06F 17/30545
USPC 707/770

(57) ABSTRACT

An apparatus and method are provided for retrieving user data from various user devices and a cloud database. The method includes receiving a query entered by a user on a first device among the plurality of user devices; searching a device index of the first device for a result of the query; searching a cloud index for the result of the query, when the result is not found in the device index of the first device; presenting a preview of the result found on the cloud index; and presenting the result to the first device.

### PRIORITY

This application claims priority under 35 U.S.C. § 119(a) to Indian Patent Application Serial No. 256/CHE/2012, which was filed in the Indian Patent Office on Jan. 20, 2012, the entire content of which is incorporated herein by reference.

### BACKGROUND OF THE INVENTION

1. Field of the Invention

The present invention relates generally to information extraction and management, and more particularly, to searching for and retrieving data from multiple devices on a cloud.

2. Description of the Related Art

With the increase in the repository of user data, various mechanisms for managing and retrieving the data from different storage devices have been developed.

More specifically, devices such as laptops, desktops, mobile phones, tablets, etc., store user data and provide access to such data when required. However, as the amount of data on the devices increases, data management and efficient retrieval becomes a major issue. Further, the demand for mechanisms that effectively retrieve the data from different devices has increased. To address this demand, various search and information extraction mechanisms have been developed.

These conventional information extraction methods employ localized search methods. In such methods, data is extracted from a particular device on which a user enters a query and searches for the information. For example, when a user wants to retrieve an audio clip that is stored on the user's mobile phone, the user enters a search query on the user interface for searching that is provided on the mobile phone. The query may include keywords that are related to the audio clip or album name, artist name, etc. The search mechanism performs a search on the mobile phone of the user for the requested audio clip and provides the search result.

However, when a requested audio clip is not stored on the mobile phone of the user, e.g., it is stored on another device, there are currently no mechanisms for retrieving the requested audio clip from the other device for the search performed on the mobile phone. Basically, there are no methods for aggregating data from various devices, which can be searched from one device.

Further, as the amount of data on a user device increases, storage of the data also becomes more difficult.

Cloud computing provides an efficient way to store large amounts of data and manage the data effectively by linking the data related to a particular user from various devices and storing the data on the cloud databases. In such an environment, when a user searches for the data, the data related to a user's web account is searched. Further, if there are multiple devices related to a user, then data may be stored on any of the user's device. However, even in this scenario, it becomes difficult to access the requested data and present the same to the user, as the conventional methods do not have indexing mechanisms.

### SUMMARY OF THE INVENTION

Accordingly, the present invention is designed to address at least the problems and/or disadvantages described above and to provide at least the advantages described below.

An aspect of the present invention is to enable access to data belonging to a user from any of the user's device.

Another aspect of the present invention is to provide a cloud database server that maintains indexes for user data.

Another aspect of the present invention is to maintain an index for data on each device of a user, which is linked to a user web account.

In accordance with an aspect of the present invention, a method is provided for processing a search query entered on the device; providing search result data regarding the search query if the search result data is present on the device; and performing a preview function of the search result data regarding the search query which is provided from a cloud server, if the search result data is not present on the device.

In accordance with another aspect of the present invention, a cloud database server is provided for linking and providing data related to a user on a user device. The server is configured for storing an index related to data stored in the multiple devices of the user; updating said index when there is a change in data on the multiple devices; performing semantic reasoning for extracting search result data corresponding to a search query entered on the device; and providing the search result data to the device.

In accordance with another aspect of the present invention, a user device is provided that aggregates and retrieves data in a cloud computing environment. The device is configured for processing a search query entered on the device and performing a search on the device for a result of the search query; aggregating search result data and providing the aggregated search result data to a user, if the search result data is found in the device; and linking the search query to a cloud server and providing the search result data provided from the cloud server to the user, if the search result data is not found in the device.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 illustrates a cloud computing system, according to an embodiment of the present invention;

FIG. 2 illustrates a cloud database server, according to an embodiment of the present invention;

FIG. 3 is a flow diagram illustrating a method of performing a search on a user device, according to an embodiment of the present invention;

FIG. 4 is a flow diagram illustrating a method of handling a search, according to an embodiment of the present invention;

FIG. 5 is a flow diagram illustrating a method of synchronization a cloud index and a device index, according to an embodiment of the present invention;

FIG. 6 illustrates index synchronization, according to an embodiment of the present invention; and

FIGS. 7A, 7B, and 7C are examples of screen shots illustrating retrieval of a search result from a cloud, according to an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness

In accordance with an embodiment of the present invention, a method is provided for linking user data from various user devices and a cloud database server, and retrieving the data. In the method, a user to accesses data stored on any of the devices that are linked to the user's web account, by employing a cloud database server. The method maintains an index on each device linked to the user's account of the data stored on the user's devices. Further, an index of user data is also maintained on the cloud database server.

When the user enters a query on one of the user devices, a search is performed on the device index to determine if the data is present on the same device. If the data is present on the same device, the result is presented to the user. However, if the data is not present on the same device, a check is made if the data is maintained on the cloud index. The cloud index maintains the index of data present on all of the devices of the user that are linked through the user's web account, e.g., a common user id. The data from the cloud database server is retrieved and presented to the user. Accordingly, the method allows the user to access to data from any of the user's device by linking the data related to user account through cloud computing.

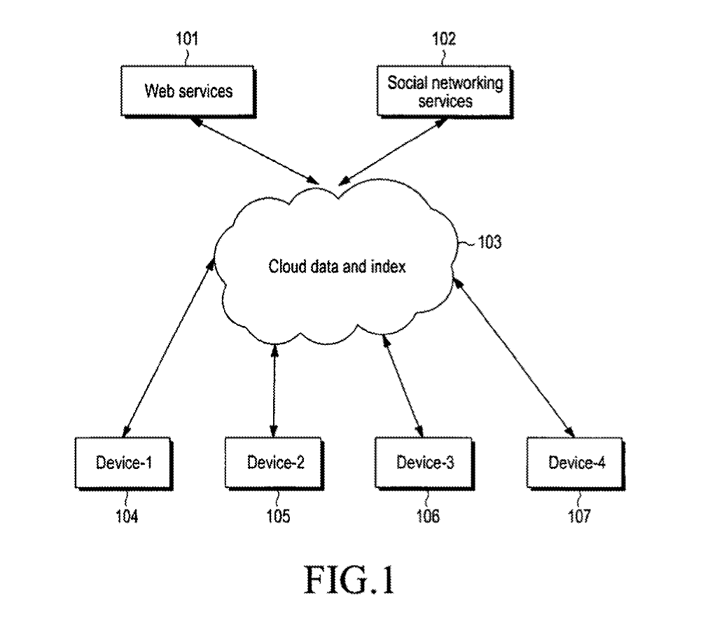

FIG. 1 illustrates a cloud computing system, according to an embodiment of the present invention.

Referring to FIG. 1, the cloud computing system includes various web services 101, social networking services 102, cloud data and an index 103 stored on the cloud, and plurality of devices 104, 105, 106, and 107.

The web service 101 maintains a web account of a user and links a user id to this account. Further, the user may link data stored on different devices through this web account. For example, a single profile is associated with the web account of the user. Additionally, data from different devices is linked to the cloud through the web service 101. The web service 101 also provides access to any form of Internet content, etc.

The social networking services 102 related to a particular user are linked with the cloud database server maintained on the cloud.

The cloud data and index 103 maintains a database of all the data for the devices related to a particular user. For each user, the system maintains an index database on the cloud. The index database on the cloud includes a backup of the index database of all the devices, an index database for all the user data on the cloud that include files, documents, email, etc. Further, an index for user data related to web accounts, such as real time data, like updates from social networking sites, and web history is maintained. The system maintains a semantic relationship among all of these indices, which helps in returning most relevant results for search queries. The cloud also maintains a common analytics database for the usage analytics corresponding to all the user data across all the devices.

Each of the device-1 104, device-2 105, device-3 106, and device-4 107, e.g., a mobile phone, a notebook, a tablet, a personal computer, a laptop, etc., maintains an index database corresponding to all the data on the particular device. For example, the devices 104-107 include a built-in integrated chip provided with a processor and a memory module. The memory module provided with a computer program code and together with the processor performing the required functionality. Herein, the term “module” refers a hardware device or a combination of hardware and software.

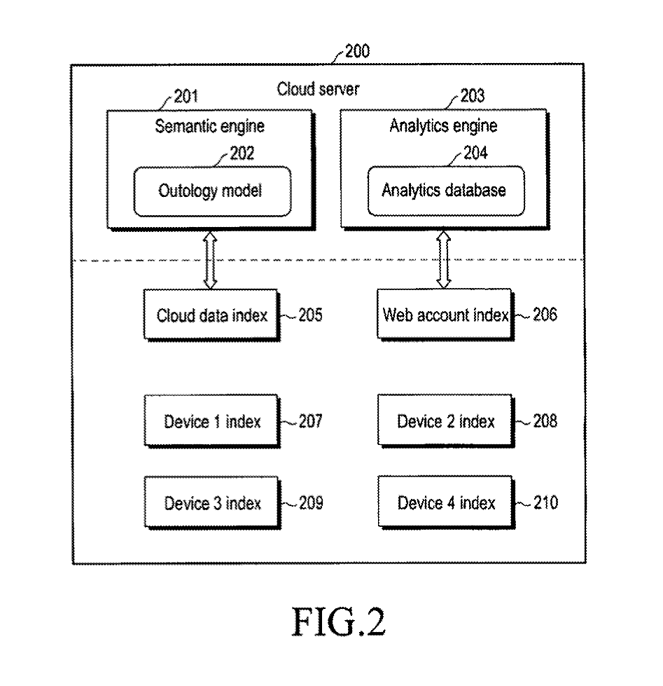

FIG. 2 illustrates a cloud database server, according to an embodiment of the present invention.

Referring to FIG. 2, the cloud server 200 includes memory devices that maintain analysis engines, and databases and indexes of the devices related to the user, so that data is aggregated and extracted efficiently. More specifically, the cloud server stores a semantic engine 201, an ontology model 202, analytics engine 203, analytics database 204, cloud data index 205, web account index 206, and device indices related to each device of the user 207, 208, 209, and 210.

The semantic engine 201 processes semantics of a search query and conducts semantic analysis on the stored data stored in the cloud database. The system maintains a semantic relationship among different index databases for a user, an index of different devices, an index for data on the cloud, and an index for data related to web accounts. With such a diverse coverage of user data, interpreting user's intent for a search query is significant for returning relevant results. The semantic reasoning applied to a search query helps to achieve the aforementioned criteria. Based on the semantics for the query, an ontological model is developed for the same, which is stored on the ontology model 202.

The analytics engine 203 helps in maintaining a common analytics database 204 on the cloud for all the user activities across different devices. The analytics engine 203 maintains user data like keyword-result mapping; most frequently used keywords, usage frequency of different applications, application-context association, etc. All this data can be useful for serving most relevant services to the user. The analyzed data from the analytics engine 203 is maintained on the analytics database 204.

The cloud server 200 maintains a cloud data index 205 for data related to the several devices of a particular user. On the user device, if there is a storage space constraint when a file is indexed, the system can move the index for the particular file to the cloud data index 205. This enables the file to be available for search and access across all the devices of the user, which otherwise would not be possible.

The web account index 206 maintains an index related to all the web accounts of a particular user. The web account index 206 is responsible for updating the user's cloud data index 205 for updates in the user data on the cloud and for updates in the user data related to the web accounts. The web account index 206 is also responsible for synchronizing the cloud data index 205 with each of the device indices 207-210 of the user. The web account index 206 acts as interface for social networking updates, tweets, and RSS feeds through a common interface by storing and indexing them on the cloud server 200.

As described above, an index corresponding to every device related to the user is maintained on the cloud server 200. In FIG. 2, a user has 4 devices, and an index related to each of the devices, i.e., Device 1 index 207, Device 2 index 208, Device 3 index 209, and Device 4 index 210, is maintained on the cloud.

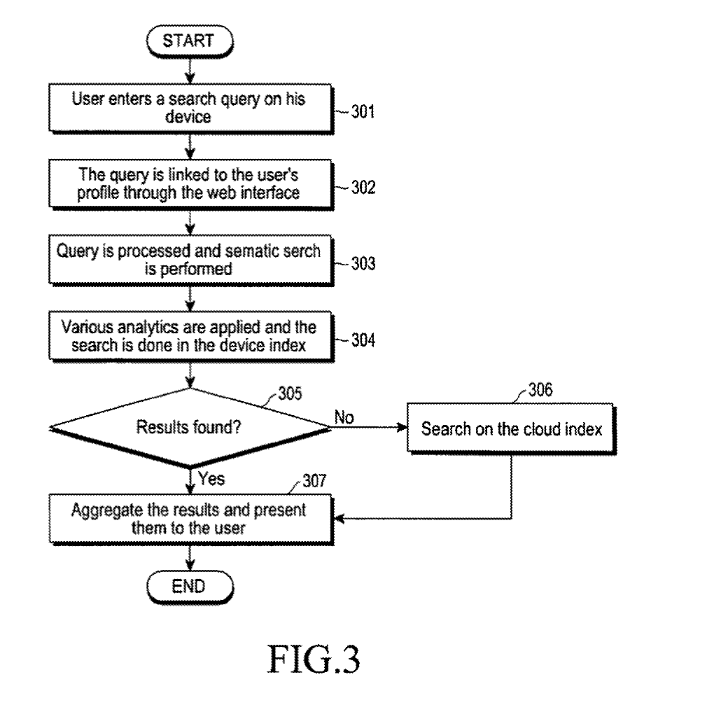

FIG. 3 is a flow diagram illustrating a method of performing a search on a user device, according to an embodiment of the present invention.

Referring to FIG. 3, when a user wants to access data of interest, e.g., a document, in step 301, the user enters a search query for the document on a device. For example, the query includes keywords for the name of the document, author, date of creation, etc.

In step 302, the query is linked to the user's profile through a web interface.

In step 303, the query is processed to identify keywords and then semantics are applied to the keywords. In step 304, various analytics are applied to the keywords from the query in order to identify the most relevant matches to the query. The search is first performed on the device on which the query is entered.

In step 305, a check is made to determine if the desired search result is found in the device on which the query is entered.

When the desired search result is not found in the device on which the query is entered, the search is performed on the cloud index database in step 306, and the data from other devices that are synced on the cloud are extracted.

After step 305 or 306, the results are aggregated in step 307 and presented to the user on the device.

For example, for data present on the cloud, a preview or snapshot of the data may first be provided to the user. Thereafter, the user may choose to download the data from the cloud database.

Additionally, search results may be presented in an order of relevancy.

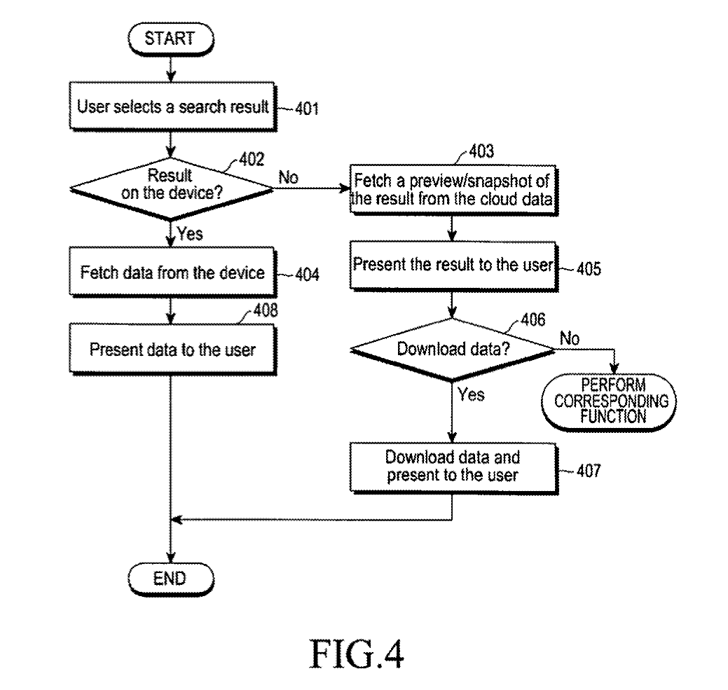

FIG. 4 is a flow diagram illustrating a method of handling a search, according to an embodiment of the present invention. Specifically, FIG. 4 illustrates a method that is performed after the user enters the search query, performs required analysis for extracting the search results, and the results are presented to the user.

Referring to FIG. 4, in step 401, the user selects the most relevant result among the results presented to the user.

In step 402, a check is made to determine if the result is on the device of the user from where the search is performed.

When the result is not on the device of the user from where the search is performed, then the result is on the cloud database server and hence, a snapshot or a preview of the same is obtained from the cloud in step 403. For example, if the selected result is a document, the system will present the user with trans-coded snapshot of the particular document. If the selected result is a multi-media file, the system will provide a preview for the same.

In step 405, the snapshot/preview is presented to the user. In step 406, a check is made to determine if the user would like to download the data from the cloud database server, and if the user would like to download the data, the data is downloaded and presented to the user in step 407.

When the user does not want to download the data in step 406, a new search or other action can be initiated.

When the result is on the device of the user from where the search is performed in step 402, the data is extracted from its location in step 404 and presented to the user in step 408.

Accordingly, the system presents the data to the user by invoking an application relevant to the data. For example, a document file will be launched using a word processing application.

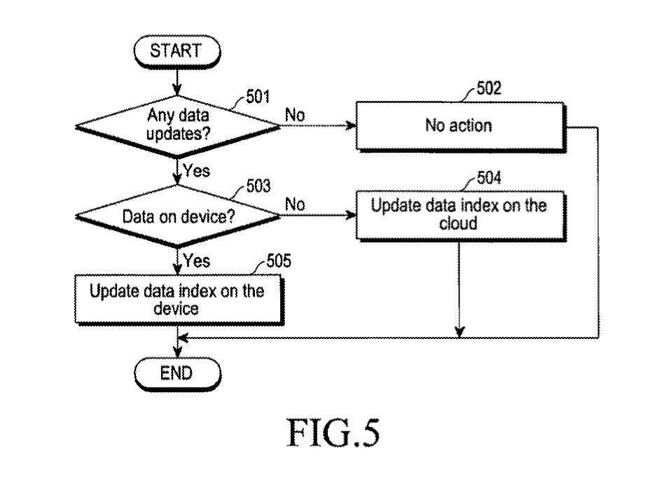

FIG. 5 is a flow diagram illustrating a method of synchronization a cloud index and a device index, according to an embodiment of the present invention.

In accordance with an embodiment of the present invention, updates involve creation of new data, and update and deletion of existing data, logs and analytic data related to searching, and updates related to the data usage. For any of these data updates on a device, its device index is updated. The device index backup on the cloud is also updated or synchronized for any changes in the index database of the device.

Referring to FIG. 5, periodic checks are performed, and if there are any updates in the data stored or any new data to be added on the device of the user or the cloud in step 501, a check is performed in step 503 to determine if there is any change on the data on the local device, i.e., the device on which the inquiry is entered. If there is a change on the data on the local device, then corresponding data on the device is updated or new data may be added in step 505. However, if there is no change on the data on the local device, then the data on the cloud database is updated or new data may be stored in step 504.

When no updates or changes to data are identified in step 501, then no action is taken in step 502.

In accordance with an embodiment of the present invention, the device index includes memory pages, and any changes in the index can be tracked by identifying the updated pages. Once the device index is updated, the updated memory pages are identified. The updated pages include the newly created memory pages and existing pages that have been updated. The updated memory pages are written to the backup index for the device on the cloud. The index synchronization with the cloud is quite efficient only a selected number of pages are written to the cloud index, i.e., those that are updated.

In accordance with an embodiment of the present invention, each time a user selects a search result corresponding to a data remote to the device, the data may be downloaded to the particular device. To avoid this, for each of the indexed user data, the system maintains a data snapshot or preview. For example, for a document, because documents are indexed using their entire text, their trans-coded representation can be generated from the index database. Snapshots of images may be provided in miniaturized or thumbnail representations. For audio/video files, a pre-listen/preview may be stored corresponding to each file. After receiving the snapshots/preview/pre-listen, the user will have an option to download the actual data to the device.

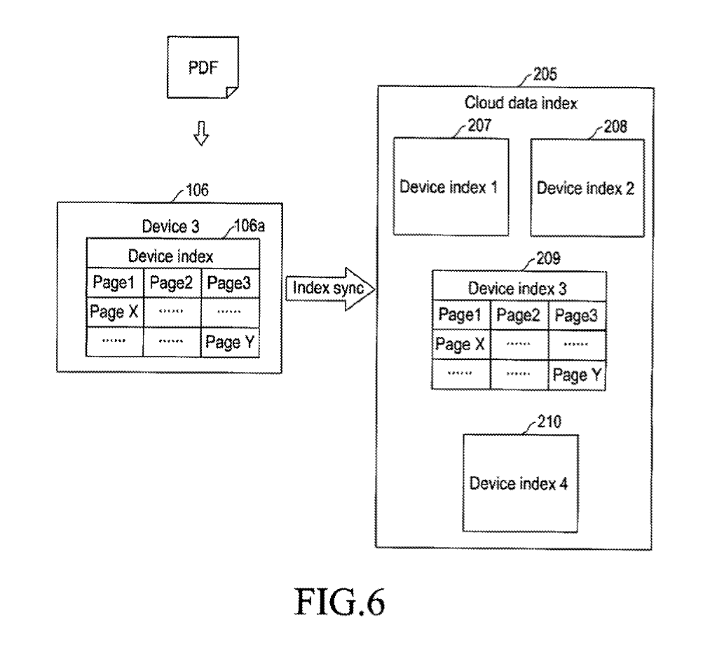

FIG. 6 illustrates index synchronization, according to an embodiment of the present invention.

Referring to FIG. 6, a change in the device index is updated on the cloud index on the cloud server. A PDF file is added to Device-3 106, as a result its device index 106a is updated. As shown, the changes in the device index 106a are identified as “Page x” and Page “y”. These changes are updated with the backup of the device index on the cloud. The update involves writing the changed pages to the cloud index. The arrow in the figure represents data synchronization to the cloud index. As a result, the changed pages get reflected on to the cloud index after the update. As shown the device index for the pages x and y are updated on the cloud database server.

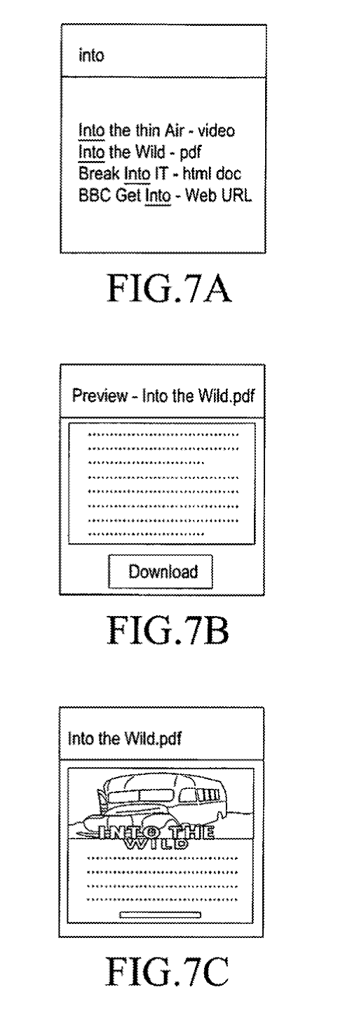

FIGS. 7A, 7B, and 7C are examples of screen shots illustrating retrieval of a search result from a cloud, according to an embodiment of the present invention. Specifically, FIGS. 7A, 7B, and 7C illustrate a sequence for accessing a file.

Referring to FIG. 7A, a user wishes to view a PDF file titled “Into The Wild.pdf” by Jon Kraukauer on a mobile phone, while PDF file is actually stored on the user's laptop. The user searches for this file by entering its file name, author, or any of the words in the text content. In FIG. 7A, the user searches for this file by the file name. The system supports incremental search and the results start appearing as the user types letters of the query. By the time the user types “into”, the desired PDF appears in the search result, as illustrated in FIG. 7A. Other results for the typed query might be matches for data present on other devices of the user or the cloud.

The user selects the result corresponding to the PDF file from the search results. Because the file for the selected result is not present on the current device, the system presents a trans-coded snapshot of the PDF file, and provides an option to download the actual file to the current device, as illustrated in FIG. 7B.

Further, when the user enters a command to download the actual file, the system retrieves the file from its actual location, i.e., the user's laptop, and downloads it to the current device, i.e., the mobile phone, as illustrated in FIG. 7C. Similarly, the user can search and retrieve any other data present on the current device, or on any other device or on the cloud.

In accordance with an embodiment of the present invention, the system synchronizes a user's index database on the cloud with the index on a device by involving only a small proportion of the memory pages of the device index. For a given change or update of data on a user's device, the device index is updated. The changes in the device index are synchronized with the cloud index by updating only a small number of updated memory pages, which in turn helps in reducing the network traffic.

In accordance with an embodiment of the present invention, the system uses a mechanism of generating trans-coded snapshots of documents from the index database on the cloud, which allows the user to access snapshots of remote documents, without actually downloading them. For a given document on a device, the system maintains a full index on the particular device by extracting its entire textual data. This also allows the retrieval of the textual data of a document without losing the textual structure. As the system maintains a backup for each index on the cloud, the snapshot for a remote document can be generated from the cloud index.

In accordance with an embodiment of the present invention, the system provides a common usage analytics for all the user data across all the devices by maintaining a common analytics database for all the devices. This data can be used for serving the most relevant ads and services to the user.

In accordance with an embodiment of the present invention, the system may employ a method of selective indexing where large documents are indexed only in the cloud index, thereby eliminating any storage constraint for indexing on a device.

In accordance with an embodiment of the present invention, the system may employ a method of moving a part of index from a device to the cloud, when the size of the local index on a device grows beyond a stipulated limit.

The above-described embodiments of the present invention may be performed by a standalone integrated circuit or an integrated circuit present within the device as described herein, where the integrated circuit is an electronic circuit manufactured by the patterned diffusion of trace elements into the surface of a thin substrate of semiconductor material. The integrated circuit further comprises of at least one processor and one memory element. The integrated circuit may be a digital integrated circuit, an analog integrated circuit, or a combination of analog and digital integrated circuits, and made available in a suitable packaging means.

Additionally, the above-described embodiments disclosed herein can be implemented through a software program running on at least one hardware device and performing network management functions to control the elements. The elements illustrated in FIG. 1 include blocks, which can be a hardware device, or a combination of hardware device and software.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method for searching for data from multiple user devices in a cloud computing environment, the method comprising:
processing a search query entered on a device;
providing search result data regarding the search query, if the search result data is present on the device; and
performing a preview function of the search result data regarding the search query, which is provided from a cloud server, if the search result data is not present on the device.

2. The method of claim 1, wherein performing the preview function comprises performing, by the cloud server, the preview function of the search result data provided from a cloud data index, if the search result data is present on the cloud data index in which a data index backup is stored for each of the multiple devices.

3. The method of claim 1, further comprising:
providing a document in the form of a snapshot to the device, if the search result data provided from the cloud server is the document; and
performing a pre-listen function of an audio file on the device, if the search result data provided from the cloud server is the audio file.

4. The method of claim 1, further comprising extracting the search result data from another device of a user on which the search result data is actually stored, and downloading the extracted search result data, if downloading is selected when the search result data is displayed through the preview function.

5. The method of claim 1, further comprising synchronizing the data index of the device with the cloud data index of the cloud server.

6. The method of claim 1, further comprising updating the data index of the device when there is a change in data on the device.

7. The method of claim 1, further comprising updating the cloud data index of the cloud server, when there is a change in data on the at least one said device of a user.

8. The method of claim 1, wherein the device is one of a mobile phone, a laptop, a desktop, and a tablet.

9. A cloud database server for linking and providing data between multiple devices of a user, the server configured for:
storing an index related to data stored in the multiple devices of the user;
updating the index when there is a change in data on the multiple devices;
performing semantic reasoning for extracting search result data corresponding to a search query entered on the device; and
providing the search result data to the device.

10. The cloud database server of claim 9, wherein the server is configured for maintaining the index on the server where the index comprises a backup data index for the data indices stored in the respective multiple devices of the user, an index for the user data on the cloud and an index for the user data related to different web accounts.

11. The cloud database server of claim 9, wherein the server is configured for updating the index periodically.

12. The cloud database server of claim 9, wherein the server is configured for aggregating the search result data and providing said the aggregated search result data to the user.

13. A user device for searching for data in a cloud computing environment, the user device configured for:
processing a search query entered on the device and performing a search on the device for a result of the search query;
aggregating search result data and providing the aggregated search result data to a user, if the search result data is found in the device; and
linking the search query to a cloud server and providing the search result data provided from the cloud server to the user, if the search result data is not found in the device.

14. The user device of claim 13, wherein the user device is one of a mobile phone, a laptop, a tablet, and a desktop.

15. The user device of claim 13, wherein the user device is configured for processing the search query where the processing comprising extracting keywords and conducting semantic reasoning.

16. The user device of claim 14, wherein the user device is configured for providing a snapshot of the search result data to the user if the search result is present on the cloud server.

17. A device for searching for data in a cloud computing environment, the device comprising:
an integrated circuit including at least one processor; and
at least one memory having a computer program code within the integrated circuit executed,
wherein the at least one memory and the computer program code are configured to, through the at least one processor, cause the device to:
process a search query input by a user;
perform a search for a result for the search query;
link the search query to a cloud server if the search result is not found on the device; and
aggregate the search result data and provide the aggregated search result to the user.

18. The device of claim 17, wherein the device is one of a mobile phone, a laptop, a tablet, and a desktop.

19. The device of claim 17, wherein the device is configured for processing the search query where the processing comprising extracting keywords and conducting semantic reasoning.

20. The device of claim 17, wherein the device is configured for providing the search result data through a preview function if the search result is present in the cloud database server.
